(19) United States
(12) Patent Application Publication
(10) Pub. No.: US 2008/0172998 A1
(43) Pub. Date: Jul. 24, 2008

(54) Guayule Harvester

(75) Inventors: Michael R. Fraley, Carefree, AZ (US); Trevor Kammann, Yuma, AZ (US)

Correspondence Address: JENNINGS, STROUSS & SALMON, P.L.C., 201 E. WASHINGTON ST., 11TH FLOOR, PHOENIX, AZ, 85004, US

(73) Assignee: Yulex Corp.

(21) Appl. No.: 12/016,936

(22) Filed: Jan. 18, 2008

Related U.S. Application Data
(60) Provisional application No. 60/897,087, filed on Jan. 22, 2007.

(51) Int. Cl. A01D 41/04; A01D 57/00

(52) U.S. Cl. 56/14.6

(57) ABSTRACT

A guayule harvester comprises a hydraulic-powered cutting and conveying device pulled and powered by a farm tractor. Guides lift the shrub and expose the trunk to a pair of horizontal circular saw blades at the same time that opposed pick-up belts engage the shrub branches and impel the shrub to an elevator conveyor belt. The elevator belt carries the now-severed shrub to the height of the entrance to a transport trailer, and then drops it onto an extendable lateral conveyor, which drops it into the carrier.

### CROSS REFERENCE TO RELATED APPLICATIONS

This application claims the benefit of priority of U.S. Provisional Application Ser. No. 60/897,087, filed Jan. 22, 2007.

### BACKGROUND OF THE INVENTION

Guayule is a desert shrub indigenous to the southwestern United States and northern Mexico. Guayule is a source of natural rubber latex, which is found primarily in the bark or the branches, trunk and root system of the shrub. Processing to extract latex involves grinding the entire plant in a batch process that gently breaks open the cells of the plant, releasing intact rubber particles and creating an aqueous solution. The solution may be centrifuged to separate the latex from the remaining solution.

The guayule shrub is optimal for harvesting and processing at two years of growth, by which time it stands about 90 cm (3′) high and has a roughly spherical branch structure about 75 cm (30″) in diameter, growing out of a stalk or stalks from 0.6 to 5 cm (¼″ to 2″) in diameter. The entire shrub is harvested, cutting the stalk about 7.5 cm (3″) above the ground. The shrubs are transported to the processing plant, where they must be processed within about 72 hours or latex content is substantially degraded.

Traditional guayule harvesting is by hand, using a tool to cut through the tough trunk. The present invention is a mechanical harvester that cuts the bush and conveys it to a large trailer, from which the bushes can be baled and then transported to the processor.

### SUMMARY OF THE INVENTION

The harvester of the present invention is a powered cutting and conveying device suitable for harvesting the guayule or any other small shrubs. Guides lift the shrub and expose the trunk to a pair of cutting blades at the same time that opposed pick-up belts engage the shrub branches and impel the shrub to an elevator conveyor belt. The elevator belt carries the now-severed shrub to the height of the entrance to a transport trailer, and then drops it. In the embodiment illustrated, the harvester is pulled behind a farm tractor and powered by the tractor's hydraulic system. An extendable lateral conveyor at the end of the main conveyor allows the harvested shrub to be dropped into a carrier pulled alongside the harvester.

### DRAWINGS

FIG. 1 is a side view of one embodiment of the invention.

FIG. 2 is a perspective view of the front portion of the harvester.

FIG. 3 is the same as FIG. 2 with the frame and shafts in phantom to reveal the pick-up belts and cutting blades.

FIG. 4 shows a plan view exposing only the pick-up belts, the cutting blades and conveyor.

FIG. 5 is a view of the separator assembly.

### DETAILED DESCRIPTION

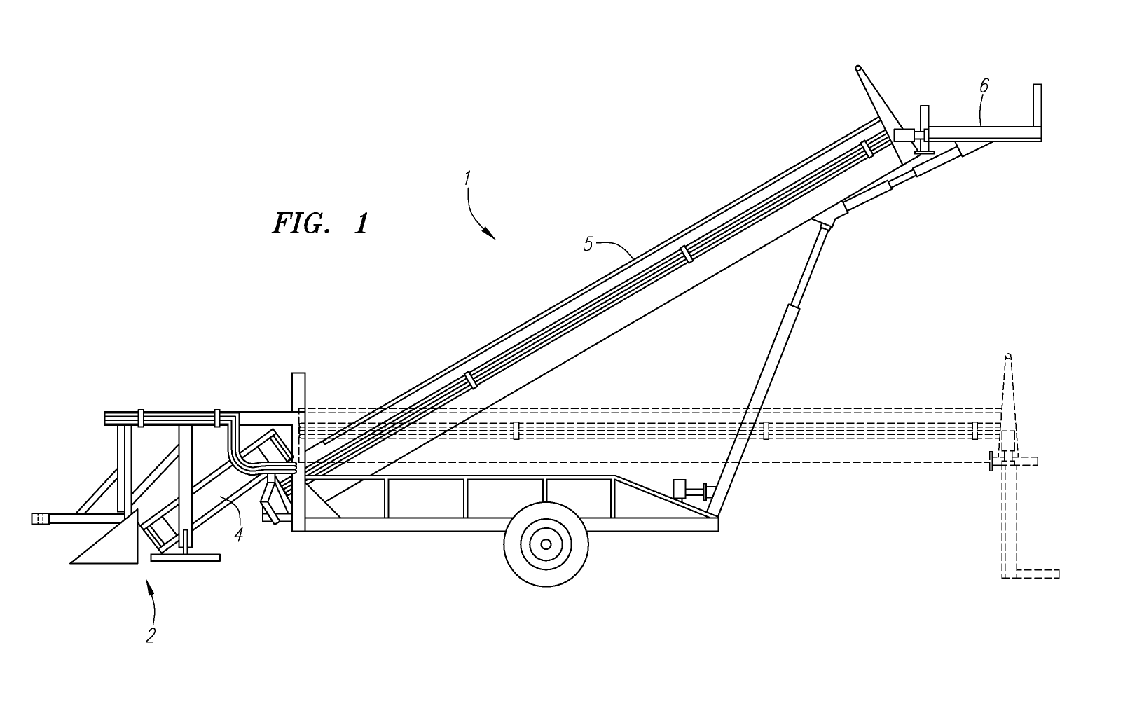

As seen generally in FIG. 1, harvester (1) is a wheel-mounted platform designed to be pulled by a tractor when in operation but which can be pulled by a “fifth-wheel” design truck for transport over the road. As the harvester is pulled along the rows of crops, cutting assembly (2) lifts the bush and severs it at the stem. Pick-up belt assemblies (4) engage the severed bush and move it to the base of conveyor (5), which carries the harvested bush to the elevation of the crop transport vehicle, which is approximately 3.75 m (12½′) in one embodiment. In one embodiment, conveyor (5) drops the bush onto lateral conveyor (6), which extends over the top of the transport vehicle and drops the bush into it.

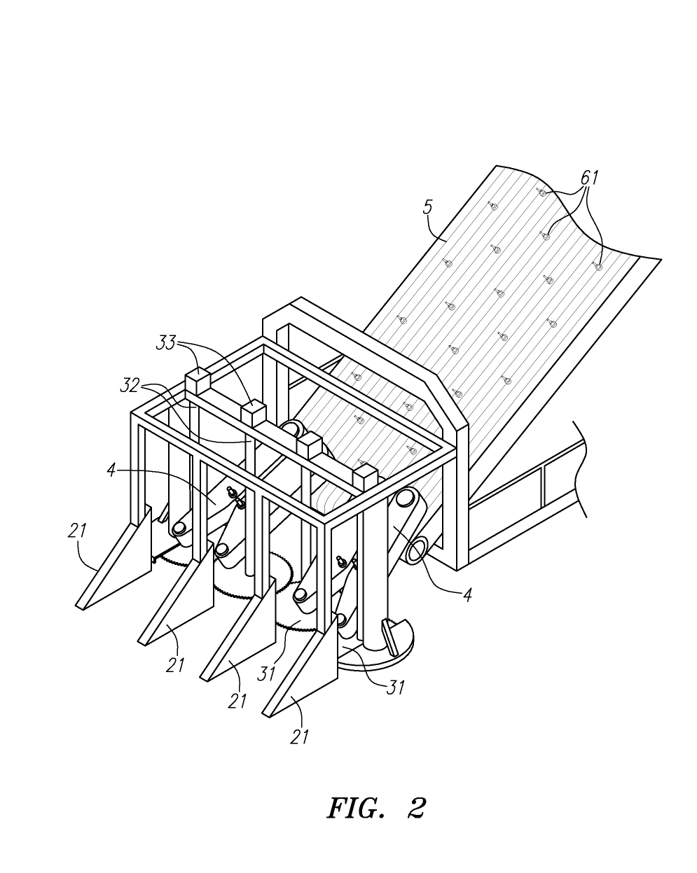

FIG. 2 shows the front end of the harvester, including separators (21) for isolating the plant and exposing the trunk, cutting blades (31) that sever the trunk of the plant, and pick-up belts (41) that engage the severed plant and move it to the conveyor.

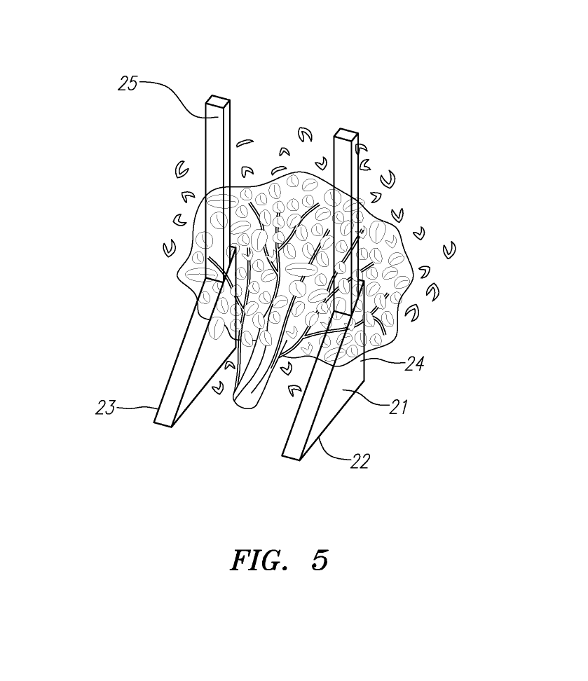

As better seen in FIG. 5, separators (21) are wedges of heavy-duty plastic or other suitable material mounted on separator stalks (25) so they are free to float up and down. In operation, the harvester is lowered by the tractor hitch so that the bottom edges (22) of the separators (21) skim along the ground surface and the cutting blades (31) are about 7.5 cm (3″) above the surface. As the harvester is pulled down the crop row, the leading edges (23) of a pair of separators (21) engage the underside of the bush from either side. The wedge shape of the separators (21) lifts the bush branches, exposing the trunk, and isolates the bush from adjacent plants. As the bush reaches the trailing edge (24) of the separators (21), its trunk is severed by blades (31) while the upper part of the bush is engaged by pick-up belt assembly (4) that moves the now-severed bush back to the conveyor. In the present embodiment, the height at the trailing edge is about 60 cm (2′), but the dimensions may be varied according to the size of the harvester apparatus and the crop being harvested.

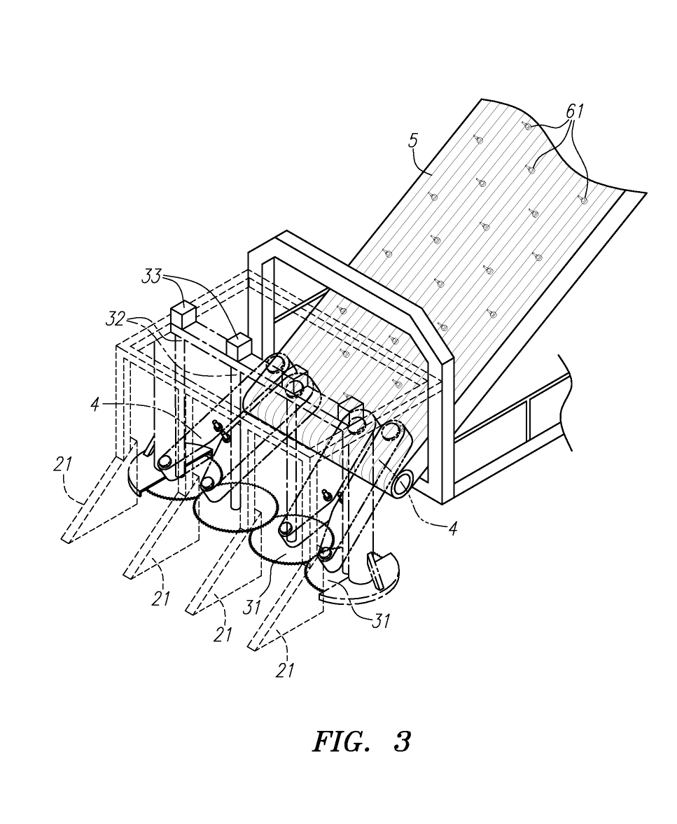

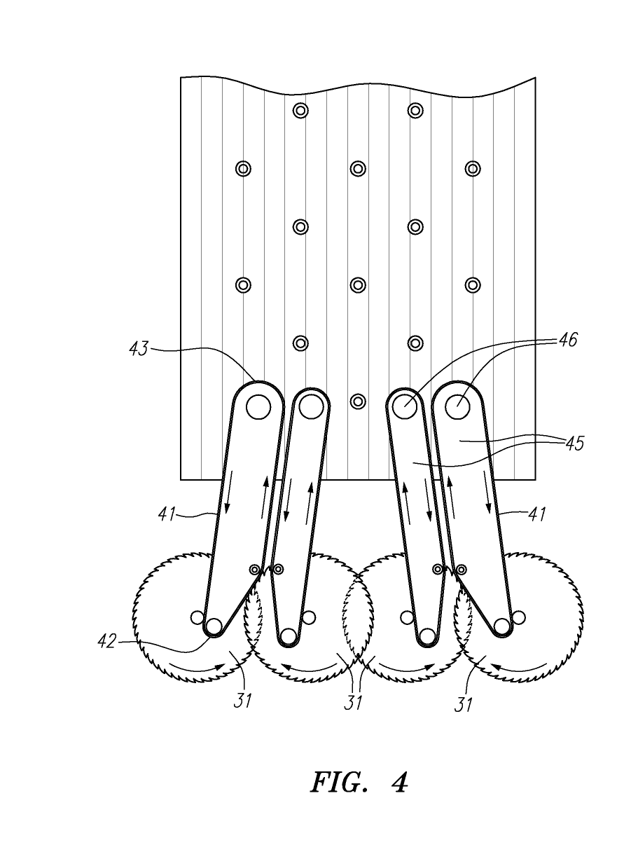

FIG. 3 shows the front end of the harvester with the separators and support frame in phantom, to better reveal the pick-up belts and cutting blades. FIG. 4 is a plan view showing just the blades and pick-up belt assemblies.

In one embodiment, blades (31) are 58 cm (23″) diameter carbon-tipped steel sawmill blades rotating at about 2000 to 2200 rpm. The blades slightly overlap and rotate in opposite directions, so that each one is moving front-to-back at the area of overlap. In this embodiment, the blades are individually powered by 7 hp hydraulic motors (33), connected by individual blade shafts (32). The motors are run off the main hydraulic line from the tractor.

As better seen in FIGS. 3 and 4, pick-up belt assemblies (4) are an opposing pair of track rotating belts (41) mounted above a pair of blades (31), with a front end (42) that extends near the front of the blade and a back end (43) that extends above the conveyor belt (6). In one embodiment, the belts are about 30 cm (1′) wide. The operating mounts (45) for the pick-up belts are of the standard track belt design with a drive motor (46) moving the belt (41). They are configured to fit between the cutting blade drive shafts (32) and at the front they are configured to angle away from each other, forming a Y-shaped opening to engage and move the bush being harvested. The opening approximately lines up with the pair of separators (21) in front of the belts and directly over the intersection of a pair of blades (31). The pick-up belts are spring tensioned to touch each other along their parallel surfaces, but the spring tension is set to allow easy separation of the belt modules as the harvested plant passes between them, while maintaining pressure against both sides of the plant to impel it along the belts.

As noted, the rear of the belt pair assembly extends above the conveyer belt, so harvested shrubs are dropped onto the conveyor belt. The pick-up belts are powered by separate hydraulic motors connected to the tractor's auxiliary hydraulic pumps.

One embodiment of the invention is configured to harvest two rows of shrubs, normally planted 1 m (40″) apart between furrows. Two sets of separators (21) run along an adjacent pair of crop rows. As the shrubs are lifted by the separators, the trunks encounter the counter-rotating cutting blades (31) at the same time that the branches are engaged by the open ends of the pick-up belts (41). The trunks are severed and the harvested shrubs are carried back to the conveyor belt.

Conveyor belt (5) is of standard design, except that a plurality of shrub engagers (61) are mounted throughout the length of the belt to keep shrubs from slipping along the belt. In one embodiment, the shrub engagers are 7.5 cm (3″) flat-head bolts passed through the belt and secured with a washer and locknut.

The conveyor belt assembly can be raised to a height of a 3.6 m (12′) crop carrier vehicle, as in FIG. 1, or lowered for transport, as shown in phantom in FIG. 1. Below the top end of the conveyor belt is an extendable lateral conveyor (6), which extends over the side of the crop carrier vehicle. Harvested shrubs drop off the conveyor belt to the lateral conveyor, then from the lateral conveyor to the crop carrier. In one embodiment, the lateral conveyor may be retracted so that it centers on the conveyor belt, then folded downward for transport.

In the embodiment illustrated here, the entire harvesting unit is operated in a conventional manner by a plurality of hydraulic motors powered by the tractor's main and auxiliary hydraulic supply lines. A feed from the main tractor pump enters a sequence of hydraulic flow separators, resulting in four uniform pressure flow lines, each of which feeds a blade motor connected by a shaft to a blade directly below the motor. Recirculating hydraulic fluid is sent to a 150 l (40-gallon) reservoir tank mounted in the base of the trailer and then returned to the flow circuit.

Additional hydraulic motors are run from the tractor's auxiliary hydraulic supply. One motor turns each of the four pick-up belts. Another motor turns the conveyor belt. Another turns the lateral conveyor. A motor lifts and lowers the conveyor ramp, and a pair of motors raises and lowers the lateral conveyor and extends and retracts it. All the associated hydraulic lines use the same reservoir.

While the invention has been described with reference to particular embodiments thereof, persons of ordinary skill in the art will readily apprehend additional configurations of the harvester that are within the scope of this invention. By way of example only, the device could be widened to harvest more than two rows at a time or configured for a single row. The harvesting mechanism may be integrated into a self-propelled vehicle or use other power means to run the various motors.

What is claimed is:

1. A harvester of shrubs, adapted to be pulled and powered by a farm tractor, comprising:
a trailer frame having a front end and back end, with wheels mounted near the back and a hitch mounted at the front end;
a plurality of plant separators, having front ends and back ends, mounted forward of and below the front end of the trailer;
at least one stem cutter positioned behind the back end of the separators;
at least one pick-up belt assembly mounted above and behind the cutter, capable of engaging and moving a severed shrub toward the rear;
a elevated conveyor belt positioned to the rear of and below the pick-up belt assembly, adapted to move a harvested bush to an elevated position to be deposited into a crop carrier.

2. The harvester of claim 1 further including an extendable lateral conveyor positioned below the back end of the elevatable conveyor belt.

3. The harvester of claim 1 wherein the cutter comprises a pair of horizontally-mounted circular saw blades.

4. The harvester of claim 3 wherein the sqw blades are counter-rotating and overlap slightly.

5. The harvester of claim 4 wherein each blade is powered by a hydraulic motor.

6. The harvester of claim 1 wherein the pick-up belt assembly is powered by a hydraulic motor.

7. The harvester of claim 1 incorporating a plurality of pairs of saw blades and associated pick-up belt assemblies mounted on a single trailer with a conveyor.

8. A harvester of shrubs, adapted to be pulled and powered by a farm tractor, comprising:
a trailer frame having a front end and back end, with wheels mounted near the back and a hitch mounted at the front end;
a plurality of plant separators, having front ends and back ends, mounted forward of and below the front end of the trailer;
at least one pair of horizontal, counter-rotating circular saw blades, each blade powered by a hydraulic motor, positioned behind the back end of the separators;
at least one pick-up belt assembly mounted above and behind the saw blades, capable of engaging and moving a severed shrub toward the rear;
a conveyor belt positioned to the rear of and below the pick-up belt assembly, adapted to move a harvested bush to an elevated position to be deposited into a high-walled crop carrier.

9. The harvester of claim 8 further including an extendable lateral conveyor positioned below the back end of the elevatable conveyor belt.

10. The harvester of claim 8 wherein the pick-up belt assembly is hydraulically powered.

11. The harvester of claim 10 wherein the saw blade motors and pick-up belt assembly are powered by a tractor hydraulic system.

4.
